(19) United States
(12) Patent Application Publication
(10) Pub. No.: US 2016/0034120 A1
(43) Pub. Date: Feb. 4, 2016

(54) INFORMATION PROCESSING APPARATUS AND INFORMATION PROCESSING SYSTEM

(71) Applicants: Takayuki YAMAOKA, Tokyo (JP); Keiichi SUZUKAWA, Tokyo (JP)

(72) Inventors: Takayuki YAMAOKA, Tokyo (JP); Keiichi SUZUKAWA, Tokyo (JP)

(73) Assignee: MITSUBISHI ELECTRIC CORPORATION, Tokyo (JP)

(21) Appl. No.: 14/776,817

(22) PCT Filed: Mar. 29, 2013
(86) PCT No.: PCT/JP2013/059686

§ 371 Date: Sep. 15, 2015

(51) Int. Cl. G06F 3/0484; G06F 3/0482

(52) U.S. Cl. CPC G06F 3/0484; G06F 3/0482

(57) ABSTRACT

An information processing apparatus includes a function-in-use discriminating unit that discriminates types of functions of a tool operated by a first user; a technical-level calculating unit that calculates the technical level of each of the functions used by the user on the basis of the operation performance of the functions as performed by the user; a communication unit that transmits, to an external storage device, technician level information in which the technical level, the first user, and the function are associated; and a technical-level-display processing unit that accesses the external storage device via the communication unit, acquires, from the technician level information, technical levels of the other users with respect to a function being used by the first user, and causes a display apparatus X1 to display the technical levels of the other users.

### FIELD

The present invention relates to an information processing apparatus and an information processing method that reveals the technical skill level of a person who is using an engineering tool.

### BACKGROUND

When information processing such as programming is performed, an engineering tool or the like is used. The engineering tool includes, for example, a help function for the tool and a function that displays the skill level with which the user uses the tool as well as the function of executing information processing.

Therefore, when a beginner or the like has problems, for example, when the beginner does not know how to use the engineering tool, the user uses the help function for the tool or refers to the tool's manual. When the user desires to know the skill level with which he or she uses the tool, the user's skill level is displayed (see Patent Literatures 1 and 2).

### CITATION LIST

### Patent Literature

Patent Literature 1: Japanese Patent Application Laid-Open No. 2004-355418

Patent Literature 2: Japanese Patent Application Laid-Open No. 2008-305339

### SUMMARY

### Technical Problem

When the user does not know how to use the engineering tool, the user sometimes cannot work things out using only the help function or the manual. Therefore, the user will often ask a person who knows more about using the engineering tool (a person having a higher technical level). In such a case, the user needs to know who has a higher technical level than him/herself. However, there is no way to find this out. In the related art, although the user can find out his or her own tool skill level, the user cannot find out the skill levels with which other users use the tool.

The present invention has been made in view of the above and it is an objective of the present invention to obtain an information processing apparatus and an information processing system that can easily acquire the skill levels of other users who use the tool.

### Solution to Problem

In order to solve the problem and achieve the objective mentioned above, the present invention relates to an information processing apparatus that includes: a function discriminating unit that discriminates types of functions of a tool operated by a first user; a technical-level calculating unit that calculates a technical level of each of the functions used by the user on the basis of operation performance for the functions used by the user; a communication unit that transmits, to an external storage device, technician level information in which the technical level, the first user, and the function are associated; and a technical-level-display processing unit. The technical-level-display processing unit accesses, when a request for acquiring technical levels of other users is input by the first user, the external storage device via the communication unit, acquires, from the technician level information, technical levels of the other users with respect to a function being used by the first user, and causes a display apparatus to display the technical levels of the other users.

### Advantageous Effects of Invention

According to the present invention, there is an effect whereby it is possible to easily acquire the tool skill levels of other user.

### BRIEF DESCRIPTION OF DRAWINGS

FIG. 1 is a diagram explaining a process for determining the technical level of a user.

FIG. 2 is a diagram explaining process for providing technical levels of other users.

FIG. 3 is a diagram illustrating the configuration of an information processing system according to a first embodiment.

FIG. 4 is a diagram illustrating the configuration of an information processing apparatus according to the first embodiment.

FIG. 5 is a flowchart explaining a processing procedure for determining the technical level of a user.

FIG. 6 is a diagram illustrating an example of function definition information.

FIG. 7 is a diagram illustrating an example of skill level information before integration.

FIG. 8 is a diagram illustrating an example of skill level information after the integration.

FIG. 9 is a diagram illustrating an example of technical level reference information.

FIG. 10 is a flowchart explaining a processing procedure for displaying technical levels of other users.

FIG. 11 is a diagram illustrating the configuration of an information processing system according to a second embodiment.

FIG. 12 is a diagram explaining process for displaying the contact details of other users simultaneously with their technical levels.

FIG. 13 is a diagram illustrating the configuration of an information processing apparatus according to the second embodiment.

FIG. 14 is a diagram illustrating an example of skill level information according to the second embodiment.

FIG. 15 is a diagram explaining process for providing a telephone counseling service center with technical levels of users.

FIG. 16 is a diagram illustrating the configuration of an information processing system according to a fourth embodiment.

FIG. 17 is a diagram illustrating the configuration of an information processing system according to the fourth embodiment.

FIG. 18 is a diagram illustrating the hardware configuration of the information processing apparatus.

### DESCRIPTION OF EMBODIMENTS

Exemplary embodiments of the present invention are explained in detail below with reference to the drawings. Note that the present invention is not limited to these embodiments.

### First Embodiment

First, the concept of information processing according to the embodiment is explained. For example, when a large system is being developed by a team, an information processing system in this embodiment displays the technical levels (tool skill levels) concerning an engineering tool (hereinafter referred to as tool) of other users in the team so that it is known who is familiar with the technology. Consequently, the information processing system enables users to help others quickly learn how to use the tool. Note that, in the embodiment, the operation of the information processing system where a plurality of users (three users: Taro, Jiro, and Hanako) are developing a sequence program is explained.

An information processing apparatus (an information processing apparatus A1 and the like explained below) included in the information processing system has a function (a function 1) whereby it records the numbers of times an operation is performed, the length of the operation (hereafter, operation time), and the like of functions that the tool has and determines the technical level that a user has for each of the functions on the basis of the numbers of times used, the operation time, and the like. The information processing apparatus A1 has a function (a function 2) of displaying the technical levels of other users when a user uses the help function. By using the functions 1 and 2, the information processing system presents the technical levels of the other users (knowledgeable people) other than the user. Consequently, the user can easily know which of the users is familiar with the function and can ask that user about the function. Therefore, the user is more quickly able to understand the function than from viewing help function.

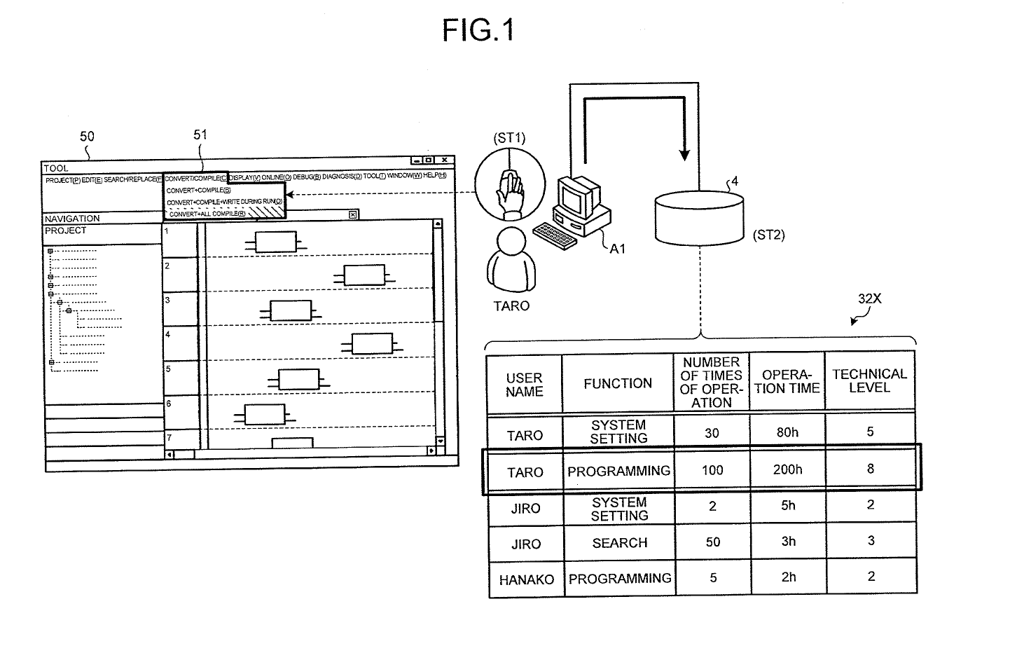

FIG. 1 is a diagram explaining process for determining the technical level of a user. For example, when a user Taro (a first person) uses a function 51 of a tool 50 included in the information processing apparatus A1 (ST1), the information processing apparatus A1 causes a storage (a technical-level recording DB 4) to store operation performance information (the number of times an operation is performed, an operation time, etc.) concerning operation of the function 51 used by Taro. When the operation performance information of Taro is already stored in the technical-level recording DB 4, the information processing apparatus A1 causes the technical-level recording DB 4 to store operation performance information obtained by combining the operation performance for each of the functions used by Taro.

The information processing apparatus A1 calculates the technical level of Taro on the basis of the operation performance information. At this point, the information processing apparatus A1 calculates the technical level of Taro for each of the types of functions. The information processing apparatus A1 causes the technical-level recording DB 4, which is an external storage device, to store the calculated technical level (ST2).

The technical-level recording DB 4 stores in advance, as skill level information 32X, operation performance information and the technical level of each of users sent from information processing apparatuses used by the users (users). The technical-level recording DB 4 stores, for example, the skill level information 32X in which a “user name”, a type of a “function”, a “number of times the operation is performed”, an “operation time”, and a “technical level” are associated. The number of times an operation is performed is, for example, the number of times the user inputs an instruction and the like to a function of a tool with a mouse, a keyboard, and the like (the number of times the function is processed). The operation time is the length of time over which the user inputs the instruction and the like to the function of the tool with the mouse, the keyboard, and the like (time from a first input to a last input) (a processing time of the function).

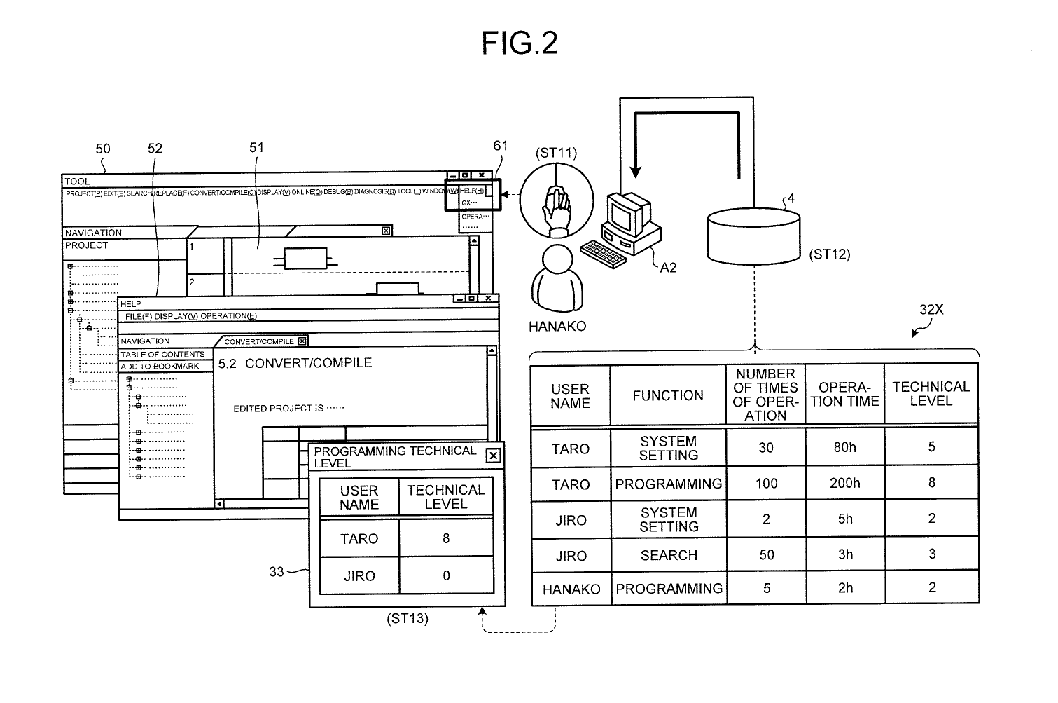

FIG. 2 is a diagram explaining process for providing technical levels of other users. For example, when a user Hanako (a second person) uses a help function 61 while using a function 51 of a tool 50 included in an information processing apparatus A2 (ST11), the information processing apparatus A2 displays help content 52 and acquires information in the technical-level recording DB 4 (ST12).

At this point, the information processing apparatus A1 acquires, from the technical-level recording DB 4, information corresponding to the type of function used by Hanako. Specifically, the information processing apparatus A2 acquires a user name and a technical level associated with a function that is the same as the function being used by Hanako.

For example, when the function used by Hanako is convert/compile a ladder program or the like, the information processing apparatus A2 determines that the function used by Hanako is programming. The information processing apparatus A2 acquires, from the skill level information 32X of the technical-level recording DB 4, a user name and a technical level associated with the function of the programming.

After acquiring the user name and the technical level associated with the function of the programming, the information processing apparatus A2 displays the acquired information as technician information 33 (ST13). In FIG. 2, the technical level of Taro is level 8 and the technical level of Jiro is level 0. Consequently, Hanako is able to know, on the basis of the displayed technician information 33, who has a high technical level.

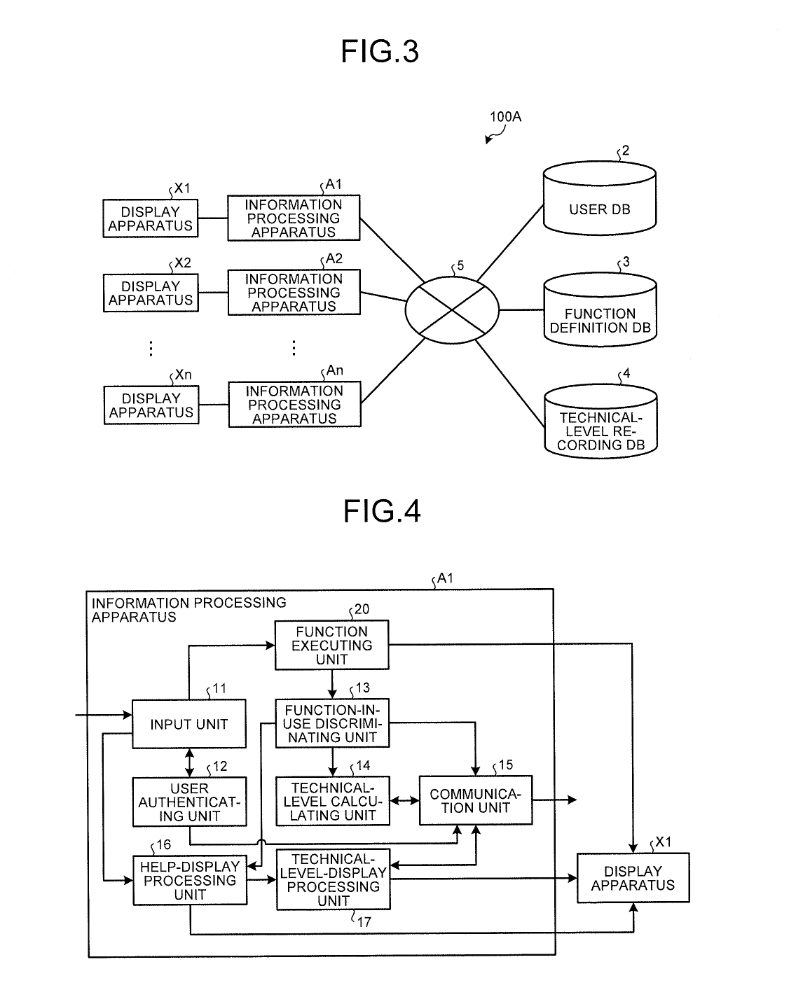

The configuration of the information processing system according to this embodiment is explained here. FIG. 3 is a diagram illustrating the configuration of the information processing system according to the first embodiment. An information processing system 100A includes information processing apparatuses A1 to An (n is a natural number), display apparatuses X1 to Xn, a user DB 2, a function definition DB 3, a technical-level recording DB 4, and a network 5.

The information processing apparatuses A1 to An are computers or the like that execute processing concerning a project. The information processing apparatus A1 is connected to the display apparatus X1; the information processing apparatus A2 is connected to the display apparatus X2; and the information processing apparatus An is connected to the display apparatus Xn. In other words, the information processing apparatuses and the display apparatuses are connected in a one-to-one relation.

The information processing apparatuses A1 to An are connected to the user DB 2, to the function definition DB 3, and to the technical-level recording DB 4 via the network 5. All of the user DB 2, the function definition DB 3, and the technical-level recording DB 4 are shared databases. The display apparatuses X1 to Xn are liquid crystal monitors or the like and they display, for example, the technical levels of the other users according to instructions from the information processing apparatuses A1 to An.

The user DB 2 is a database in which user authentication information (e.g., a correspondence relation between user identification information and passwords) used for user authentication is stored. The function definition DB 3 is a database in which information indicating definitions of functions (function definition information 31 explained below) is stored. The function definition information 31 is information indicating a correspondence relation between functions and operation. The technical-level recording DB 4 is a database in which the skill level information 32X including operation performance information and technical levels is stored.

FIG. 4 is a diagram illustrating the configuration of the information processing apparatus according to the first embodiment. Note that, because the information processing apparatuses A1 to An include the same configuration, the configuration of the information processing apparatus A1 is explained.

The information processing apparatus A1 includes an input unit 11, a user authenticating unit 12, a function-in-use discriminating unit 13, a technical-level calculating unit 14, a communication unit 15, a help-display processing unit 16, a technical-level-display processing unit 17, and a function executing unit 20 functioning as an engineering tool. Among the functions, the user authenticating unit 12, the function-in-use discriminating unit 13, the technical-level calculating unit 14, the communication unit 15, the help-display processing unit 16, and the technical-level-display processing unit 17 are tools that indicate technical levels.

Note that at least one of the user authenticating unit 12, the function-in-use discriminating unit 13, the technical-level calculating unit 14, the help-display processing unit 16, and the technical-level-display processing unit 17 can be included in the function executing unit 20. The technical-level presenting tool and the engineering tool can be effected as, for example, S/W (software) on a PC (Personal Computer).

The information processing apparatus A1 in this embodiment executes processing concerning a project (processing performed using the function executing unit 20), process for collecting the skill level information 32X, and process for displaying the technician information 33.

The input unit 11 inputs information in user authentication (user information), an instruction for operating a tool (a tool operation instruction), an instruction for displaying a help function (a help display instruction), and the like. The input unit 11 sends the user information to the user authenticating unit 12. The user information is, for example, user identification information and a password for identifying the user. When an authentication result indicating successful determination is sent from the user authenticating unit 12, the input unit 11 receives the tool operation instruction and the help display instruction. The input unit 11 sends the received tool operation instruction to the function executing unit 20. The input unit 11 sends the received help display instruction to the help-display processing unit 16.

The user authenticating unit 12 accesses the user DB 2 via the communication unit 15. The user authenticating unit 12 performs user authentication on the basis of the user authentication information (the correspondence relation between the user identification information and the passwords) stored in the user DB 2 and the input user information. The user authenticating unit 12 sends the authentication result to the input unit 11.

The function executing unit 20 executes various functions concerning the project according to the tool operation instruction. The functions concerning the project are a programming function, a debugging function, a search function, a system setting function, and the like. The function executing unit 20 executes various kinds of processing while causing the display apparatus X1 to display the content and the like being processed.

The function-in-use discriminating unit 13 discriminates, on the basis of processing executed by the function executing unit 20, which function is being used. At this point, the function-in-use discriminating unit 13 accesses the function definition DB 3 via the communication unit 15. The function-in-use discriminating unit 13 determines, on the basis of the function definition information 31 in the function definition DB 3 and a tool operation instruction (screen selection, menu selection, etc.) input from the user, the type of function being performed.

The function-in-use discriminating unit 13 calculates, for example, an operation time of the function on the basis of time from it being selected from the menu to the next selection being made from the menu. The function-in-use discriminating unit 13 can calculate the operation time of the function on the basis of the period of time from the screen selection time to the time when another screen is selected.

The function-in-use discriminating unit 13 calculates, for example, the number of times that an operation of the function is performed on the basis of the number of times it is selected from a menu for executing the function or the number of times an input is keyed in. The function-in-use discriminating unit 13 sends operation performance information such as the operation time of the function and the number of times an operation of the function is performed to the technical-level calculating unit 14. The function-in-use discriminating unit 13 sends the discriminated type of the function to the help-display processing unit 16.

The technical-level calculating unit 14 calculates the technical level of each of the functions used by the user on the basis of the operation performance information. The technical-level calculating unit 14 calculates the technical level of a function used by the user authenticated by the information processing function A1. That is, the technical-level calculating unit 14 of the information processing apparatus A1 calculates the technical level of a function used by the user of the information processing apparatus A1.

The technical-level calculating unit 14 generates the skill level information 32X in which user identification information (user names, etc.), types of functions, operation performance information, and technical levels are associated. The technical-level calculating unit 14 transmits the skill level information 32X to the technical-level recording DB 4 via the communication unit 15 to thereby store the skill level information 32X in the technical-level recording DB 4.

When the skill level information 32X corresponding to a combination of the user identification information and the function are already stored in the technical-level recording DB 4, the technical-level calculating unit 14 reads the stored skill level information 32X. Specifically, the technical-level calculating unit 14 accesses the technical-level recording DB 4 and determines whether the operation performance information calculated this time is stored. When the operation performance information calculated this time is stored, the technical-level calculating unit 14 reads the skill level information 32X.

The technical-level calculating unit 14 integrates the operation performance information calculated this time with the operation performance information of the read skill level information 32X. In other words, the technical-level calculating unit 14 adds the number of times an operation is performed and the operation time to a record of the function used by the user to thereby perform integration process for the operation performance information. Specifically, the technical-level calculating unit 14 adds the operation performance information calculated this time to operation performance information calculated so far to thereby calculate the latest operation performance information.

Further, the technical-level calculating unit 14 calculates the latest technical level of each of the functions on the basis of the latest operation performance information (after the integration). The technical-level calculating unit 14 calculates the technical level of the function used by the user of the information processing apparatus. Specifically, the technical-level calculating unit 14 calculates the technical level of the function used by the user by using the total of the numbers of times an operation is performed after the integration and the sum of operation times after the integration. The technical-level calculating unit 14 stores (overwrites) the latest operation performance information and the latest technical level in the skill level information 32X in the technical-level recording DB 4. Consequently, the skill level information 32X in the technical-level recording DB 4 is updated.

The communication unit 15 performs data communication with the user DB 2, the function definition DB 3, and the technical-level recording DB 4 via the network 5. In this embodiment, the communication unit 15 performs data communication with the other information processing apparatuses (the information processing apparatuses A2 to An) via the network 5.

When a help display instruction (a request for acquiring the technical levels of the other users) is sent from the input unit 11, the help-display processing unit 16 causes the display apparatus X1 to display help (a help page, a manual, etc.) corresponding to the type of function sent from the function-in-use discriminating unit 13. The help page, the manual, or the like are stored in a memory (not illustrated in the figure) or the like in advance. The help-display processing unit 16 sends the help display instruction and the type of function to the technical-level-display processing unit 17.

When receiving the type of function and the help display instruction, the technical-level-display processing unit 17 reads the skill level information 32X via the communication unit 15. Specifically, the technical-level-display processing unit 17 accesses the technical-level recording DB 4 and reads the skill level information 32X corresponding to the type of the function (the function being executed by the function executing unit 20) from the technical-level recording DB 4. The technical-level-display processing unit 17 causes the display apparatus X1 to display the technician information 33 (a technician level list for each of the users) from the read skill level information 32X. Consequently, the display apparatus X1 displays a list of users and technical levels for the function being executed.

Note that the user authenticating unit 12 can send the authentication result to the function executing unit 20 or to the help-display processing unit 16. In this case, when the authentication result indicating a successful determination is sent from the user authenticating unit 12, the function executing unit 20 receives the tool operation instruction from the input unit 11. When the authentication result indicating the successful determination is sent from the user authenticating unit 12, the help-display processing unit 16 receives a help display instruction from the input unit 11.

A processing procedure (a flow of work performed using a tool) of the information processing system 100A according to this embodiment is explained here. In the following explanation, a process for determining the technical level of the user Taro (an expert) and process for providing the user Hanako (a beginner) with technical levels of the other users (Taro and Jiro) are explained. In this case, it is assumed that the user Taro uses the information processing apparatus A1 and the user Hanako uses the information processing apparatus A2. First, the flow of process for determining the technical level with which each of the users is using their respective function is explained.

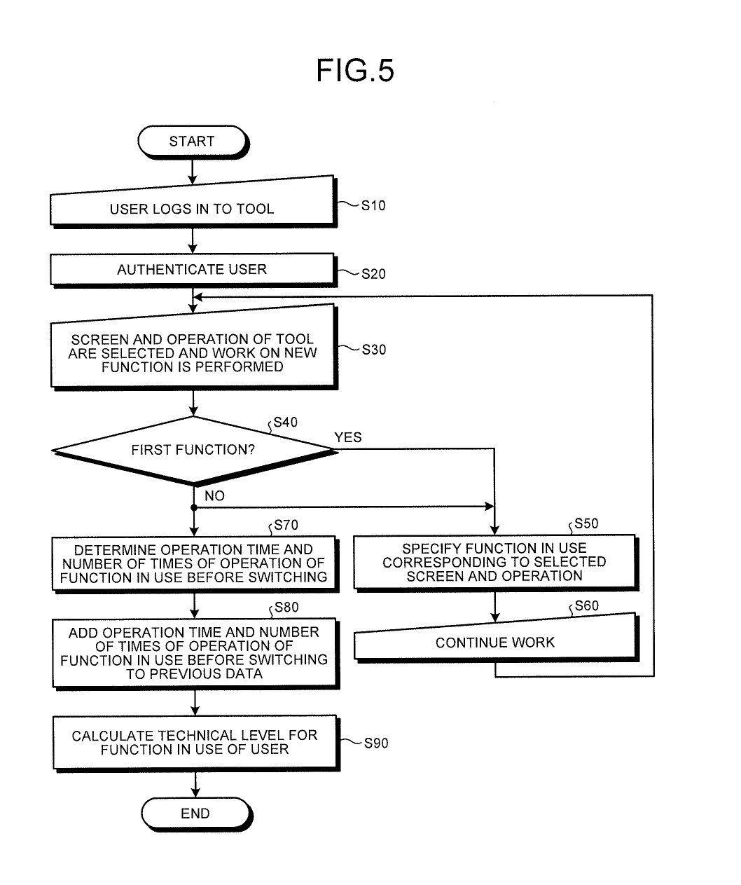

FIG. 5 is a flowchart explaining a processing procedure for determining the technical level of a user. The user (Taro) starts the tool and logs in to the tool (step S10). At this point, the user authenticating unit 12 performs user authentication on the basis of a password and the like (step S20). If the user authentication is successful, setting of the user=Taro is performed in the information processing apparatus A1.

In the information processing apparatus A1, a screen and operation of the tool are selected by the user. Consequently, work on a new function (a first function) selected by the user is started (step S30). Specifically, an instruction for designating the screen of the tool and an instruction for designating the operation are input to the input unit 11 as the tool operation instruction.

The tool operation instruction is sent from the input unit 11 to the function executing unit 20. The function executing unit 20 opens, according to the tool operation instruction, for example, a ladder editor screen for creating a sequence program. The function executing unit 20 starts, for example, a convert/compile operation of a program according to the tool operation instruction.

When the function executing unit 20 starts a processing designated by the user, the function-in-use discriminating unit 13 determines whether the processing designated by the user (processing corresponding to the selected screen and the selected operation) is processing performed by the first function (step S40).

When the processing designated by the user is the processing performed by the function designated first after the login of the user (Yes at step S40), the function-in-use discriminating unit 13 specifies a function (a type of a function in use) corresponding to a combination of the screen and the operation of the tool selected by the user (step S50). Specifically, the function-in-use discriminating unit 13 reads the function definition information 31 in the function definition DB 3. The function-in-use discriminating unit 13 specifies, on the basis of the function definition information 31, the function corresponding to the combination of the screen and the operation of the tool selected by the user.

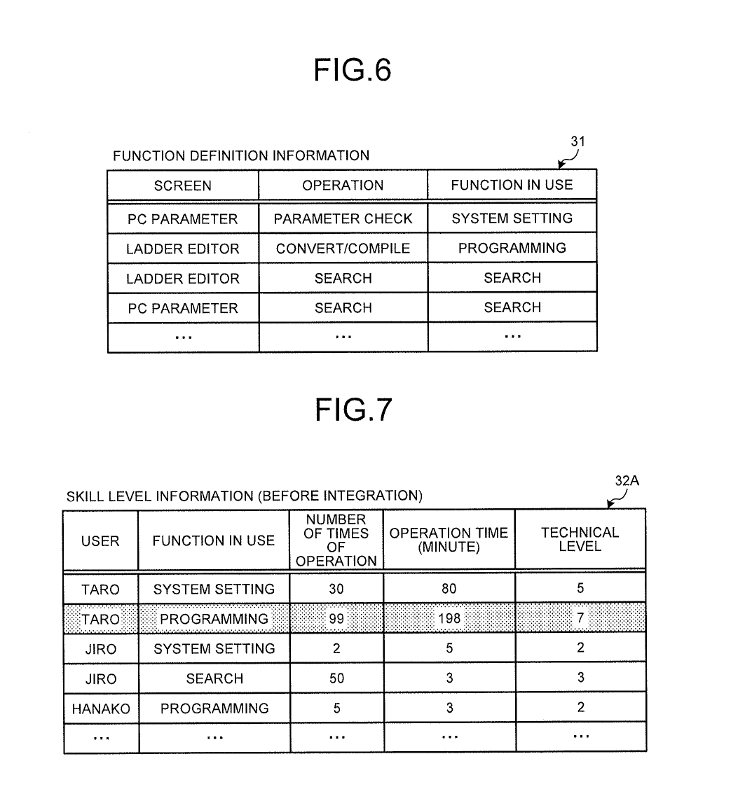

The function definition information 31 stored in the function definition DB 3 is explained here. FIG. 6 is a diagram illustrating an example of the function definition information. The function definition information 31 is a data table in which a “screen”, “operation”, and a “function in use” are associated. The “screen” is a screen selected by the user. The “operation” is an operation designated by the user. The “function in use” is a function (a function being used) corresponding to the “screen” and the “operation”.

For example, when the screen of a ladder editor is selected and operation to convert/compile is performed by the user, programming processing is executed. In this case, the function-in-use discriminating unit 13 determines that a function currently being used is programming.

When a setting screen for PC parameters is selected and an operation for performing a parameter check is performed by the user, system setting processing is executed. In this case, the function-in-use discriminating unit 13 determines that the function currently being used is system setting. Note that the function-in-use discriminating unit 13 can specify the convert/compile operation or the parameter check operation by the selection of a menu item or the determining of a key input.

After specifying the type of the function being used, the function-in-use discriminating unit 13 starts measurement of the operation time and the number of times an operation is performed for the function being used. The user continues the work using the function of the tool according to the selected screen and the selected operation (step S60).

Thereafter, when a screen or operation of the tool is selected by the user anew, switching to a new function is performed. Consequently, work on the new function (a second function) selected by the user is started (step S30). For example, when an operation such as a search, which is an operation other than the convert/compile on the ladder editor screen, is performed, a search, which is a function after a change, is executed. The function-in-use discriminating unit 13 determines whether processing designated by the user is processing performed by a first function after the login of the user (step S40).

When the processing designated by the user is processing performed by a function (a second or subsequent function) other than the function designated first (No at step S40), processing in the following steps S70 to S90 and processing in the steps S50 and S60 are performed in parallel.

Specifically, the function-in-use discriminating unit 13 ends the measurement of the operation time and the number of times operation of the function is performed before the switching and determines the operation time and the number of times the operation of the function is performed before the switching (step S70). Note that, when the function in use cannot be specified (when the set of the screen and the operation is not defined in the function definition information 31), the function-in-use discriminating unit 13 determines that there is no function in use. In this case, the function-in-use discriminating unit 13 does not perform the measurement of the operation time and the like.

The function-in-use discriminating unit 13 sends the calculated operation time and the calculated number of times an operation is performed to the technical-level calculating unit 14 as operation performance information. The technical-level calculating unit 14 integrates the calculated operation time and the calculated number of times an operation is performed with the skill level information 32X in the function level recording DB 4. Specifically, the technical-level calculating unit 14 adds the operation time and the number of times an operation of the function in use is performed before the switching to the previous data (operation time and number of times of operation) (step S80).

Further, the technical-level calculating unit 14 calculates a technical level for the function being used by the user on the basis of the integrated operation time and the integrated number of times the operation is performed (step S90). Specifically, the technical-level calculating unit 14 calculates a technical level of the user for the function before the switching on the basis of the latest operation performance information after the integration. The technical-level calculating unit 14 stores the latest operation performance information and the latest technical level in the skill level information 32X in the technical-level recording DB 4.

While the technical-level calculating unit 14 is calculating the technical level, the function-in-use discriminating unit 13 specifies a new function (step S50) and it continues the work using the new function (step S60).

In this way, after the switching to the new function is performed, the process for specifying a new function after the switching and using the new function (steps S50 and S60) and the calculation process for a technical level for the old function before the switching (steps S70 to S90) are performed in parallel.

FIG. 7 is a diagram illustrating an example of the skill level information before the integration. In FIG. 7, skill level information 32A, which is an example of the skill level information 32X, is illustrated. The skill level information 32A is a data table in which a “user”, the type of a “function in use”, the “number of times an operation is performed”, an “operation time”, and a “technical level” are associated.

In the skill level information 32A, for example, 99 times of the “number of times of operation is performed”, 198 minutes of the “operation time”, and a level 7 of the “technical level” are registered with respect to a combination of Taro as the “user” and programming of the “function in use”.

In this case, it is assumed that Taro operates the programming for the operation time of 2 minutes and the number of times the operation is performed is once. In this case, the technical-level calculating unit 14 integrates the operation time of 2 minutes and one time that is the number of times the operation is performed with the programming of Taro in the skill level information 32A.

Specifically, the technical-level calculating unit 14 integrates the operation time of 2 minutes and one time that is the number of times the operation is performed with operation performance information (the number of times an operation is performed and an operation time) corresponding to the programming of Taro in the skill level information 32A. Further, the technical-level calculating unit 14 calculates a technical level with respect to the operation performance information after the integration.

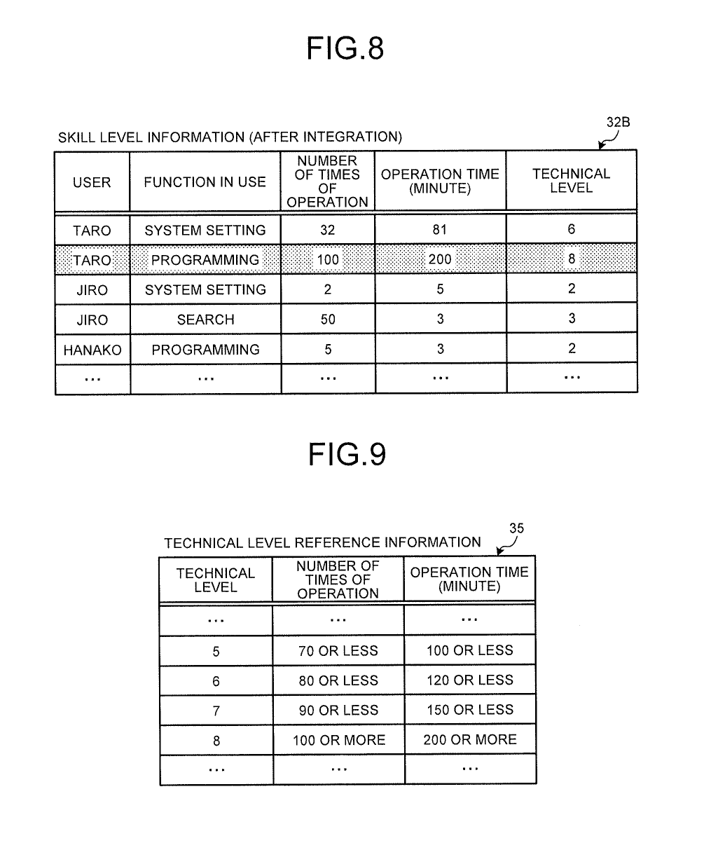

FIG. 8 is a diagram illustrating an example of the skill level information after the integration. In FIG. 8, skill level information 32B, which is an example of the skill level information 32X, is illustrated. In the skill level information 32B, the operation time of 2 minutes and the number of times an operation is performed, which is once, are integrated with the programming of Taro in the skill level information 32A. In the skill level information 32B, 100 times as the “number of times an operation is performed” and 200 minutes as the “operation time” are registered with respect to a combination of Taro of the “user” and the programming of the “function in use”.

When calculating the technical level, the technical-level calculating unit 14 uses, for example, information (technical level reference information) serving as a calculation reference for the technical level. FIG. 9 is a diagram illustrating an example of the technical level reference information.

Technical level reference information 35 is a data table in which a “technical level”, a “number of times an operation is performed”, and an “operation time” are associated. The technical-level calculating unit 14 extracts, from the technical level reference information 35, the “technical level” that satisfies both of the “number of times an operation is performed” and the “operation time”. For example, when the “number of times an operation is performed” is 100 times and the “operation time” is 200 minutes, the technical-level calculating unit 14 extracts the level 8 as the “technical level”. The technical-level calculating unit 14 registers the extracted “technical level” in the skill level information 32B. In the skill level information 32B, the “technical level” of level 8 is registered with respect to a combination of Taro of the “user” and the programming of the “function in use”.

In this way, technical levels of the users are calculated and compiled as a database on the basis of functions used by the users and operation performance. Therefore, it is possible to calculate a technical level on the basis of operations performed by the user without the user performing an actual calculating operation.

Note that, in this embodiment, the technical level is calculated on the basis of both of the “number of times an operation is performed” and the “operation time”. However, the technical-level calculating unit 14 can calculate the technical level using one of the “number of times an operation is performed” and the “operation time”.

The technical-level calculating unit 14 can calculate the technical level with using a first technical level calculated on the basis of the “number of times an operation is performed” and a second technical level calculated on the basis of the “operation time”. In this case, the technical-level calculating unit 14 can calculate the technical level by using an average of the first and second technical levels. The technical-level calculating unit 14 can adopt the lower technical level of the first and second technical levels or can adopt a higher technical level.

The technical-level calculating unit 14 can store, in the technical-level recording DB 4, both of the first technical level calculated on the basis of the “number of times an operation is performed” and the second technical level calculated on the basis of the “operation time”. In this case, both of the first and second technical levels are provided to the other users.

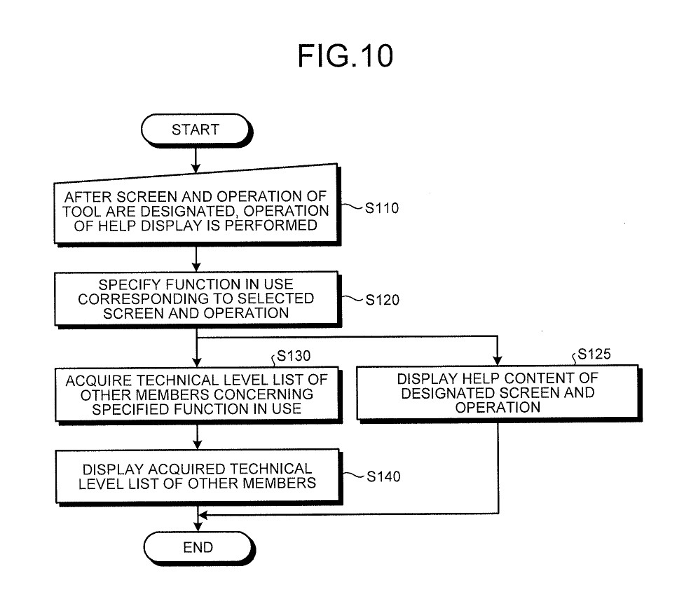

The flow of the process for displaying technical levels of the other users is explained here. FIG. 10 is a flowchart explaining a processing procedure for the process for displaying technical levels of the other users. A user (Hanako) starts the tool and longs in to the tool. At this point, user authentication is performed.

In the information processing apparatus A2, a screen and operation of the tool are selected by the user. Consequently, work selected by the user is started. Specifically, an instruction for designating the screen of the tool and an instruction for designating an operation are input through the input unit 11 as the tool operation instruction.

The tool operation instruction is sent from the input unit 11 to the function executing unit 20. The function executing unit 20 opens, according to the tool operation instruction, for example, a ladder editor screen for creating a sequence program. The function executing unit 20 starts, for example, a convert/compile operation of a program according to the tool operation instruction. Further, operation of the help display is performed by the user (step S110).

The operation of the help display (a help display instruction) is sent from the input unit 11 to the help-display processing unit 16. The function-in-use discriminating unit 13 of the information processing apparatus A2 specifies a function being used according to processing that is the same as the processing of the function-in-use discriminating unit 13 of the information processing apparatus A1 (processing same as step S50 in FIG. 5). Specifically, the function-in-use discriminating unit 13 specifies, on the basis of the function definition information 31, the type of function (a function being used) corresponding to the screen and the operation of the tool selected by the user (step S120).

Because the screen of the ladder editor is selected and the operation of the convert/compile is performed, the function-in-use discriminating unit 13 specifies that the function currently being used is programming.

The function-in-use discriminating unit 13 sends the specified function in use to the help-display processing unit 16. Consequently, the help-display processing unit 16 causes the display apparatus X2 to display help content corresponding to the function (the screen and the operation) (step S125).

The help-display processing unit 16 sends a help display instruction and the specified type of the function to the technical-level-display processing unit 17. The technical-level-display processing unit 17 acquires, on the basis of the specified function in use, a list of technical levels of the other users (technical levels associated with user names) associated with the function in use from the skill level information 32X (step S130). The technical-level-display processing unit 17 acquires a technical level list of the other users concerning programming.

For example, when the latest skill level information 32X is the skill level information 32B, the technical-level-display processing unit 17 acquires the level 8 of Taro as the technical level of the other users concerning programming. Programming, which is the function in use, is not registered for the user Jiro (the number of times an operation is performed is 0 and the operation time is 0). Therefore, the technical-level-display processing unit 17 acquires a level 0 for Jiro as the technical level.

The technical-level-display processing unit 17 causes the display apparatus X2 to display the acquired information (the technical level list of the other users) as the technician information 33 (step S140). At this point, the display apparatus X2 displays the technical level list and the help display screen, for example, simultaneously. In this way, the user Hanako seeking help for the convert/compile function of the ladder editor can easily know which user has a high technical level.

Note that, when the technical levels of the other users are displayed, the information processing apparatus A2 performs process for determining the technical level of a function according to the processing that is the same as the processing of the information processing apparatus A1 (the processing explained with reference to FIG. 5).

The technical-level-display processing unit 17 can display the “number of times an operation is performed” or the “operation time” together with the “technical level” as the technical level list. The technical-level-display processing unit 17 can display the technical level of a person together with the technical level of other people. Consequently, a person is capable of easily selecting a person having a technical level higher than the technical level of him or herself out of the technical level list data and asking the selected person a question.

The operation performance information (the number of times an operation is performed, the operation time, etc.) can be stored in the information processing apparatuses A1 to An without being stored in the technical-level recording DB 4. In this configuration, in the technical-level recording DB 4, information (technician level information) in which user identification information (user names, etc.), types of functions, and technical levels are associated is stored. In the information processing apparatuses A1 to An, operation performance information of each of the functions is stored. Consequently, the information processing apparatuses A1 to An are capable of calculating the technical level of each of the functions without accessing the technical-level recording DB 4.

Note that, when the function of the tool has a plurality of sub-functions, the technical-level calculating unit 14 can calculate the technical level for each of the sub-functions on the basis of operation performance for the sub-functions. For example, when programming of a ladder program and programming of a C language are present in the programming, the technical-level calculating unit 14 calculates the technical level for each of the program languages that are used for the programming.

The technical-level calculating unit 14 can limit the sub-function for calculating a technical level. In this configuration, the technical level of the sub-function set as a calculation target is stored in the function definition DB 3. For example, the technical-level calculating unit 14 can calculate a technical level with respect to only programming of a ladder program and store the technical level in the function definition DB 3.

The technical-level calculating unit 14 can add weighting to a formula in the technical level calculation for each of the sub-functions. In this case, weightings of the sub-functions are stored in the function definition DB 3. Consequently, it is possible to find a user having an appropriate technical level of a particular subject. Therefore, the users can quickly understand functions.

Note that, in this embodiment, the information processing apparatuses A1 to An include the help-display processing unit 16. However, the information processing apparatuses A1 to An do not have to include the help-display processing unit 16. In this case, the discrimination result (the specified function) of the function-in-use discriminating unit 13 is sent to the technical-level-display processing unit 17. The help display instruction is sent from the input unit 11 to the technical-level-display processing unit 17.

As explained above, according to the first embodiment, the tool skill levels (the technical levels) of the users are calculated on the basis of the operation performance of the functions used by the users. Therefore, it is possible to easily know the tool skill levels of the other users.

### Second Embodiment

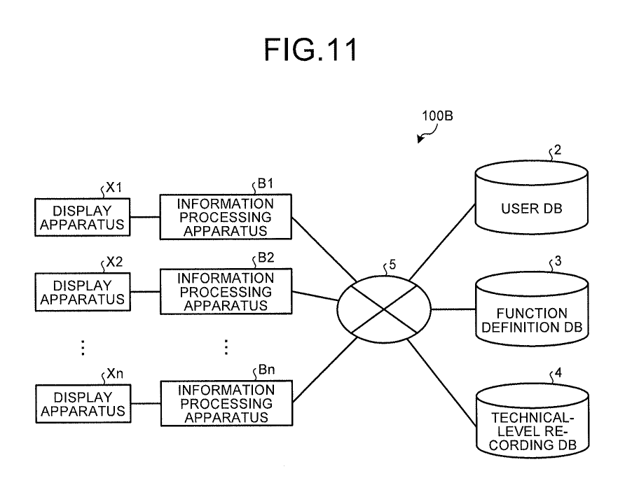

A second embodiment of the present invention is explained with reference to FIG. 11 to FIG. 14. In the second embodiment, contacts of other users are displayed simultaneously with technical levels of the other users.

FIG. 11 is a diagram illustrating the configuration of an information processing system according to the second embodiment. In an information processing system 100B according to this embodiment, information processing apparatuses B1 to Bn are connected to the network 5 instead of the information processing apparatuses A1 to An. In this way, the information processing system 100B includes the information processing apparatuses B1 to Bn, the display apparatuses X1 to Xn, the user DB 2, the function definition DB 3, the technical-level recording DB 4, and the network 5.

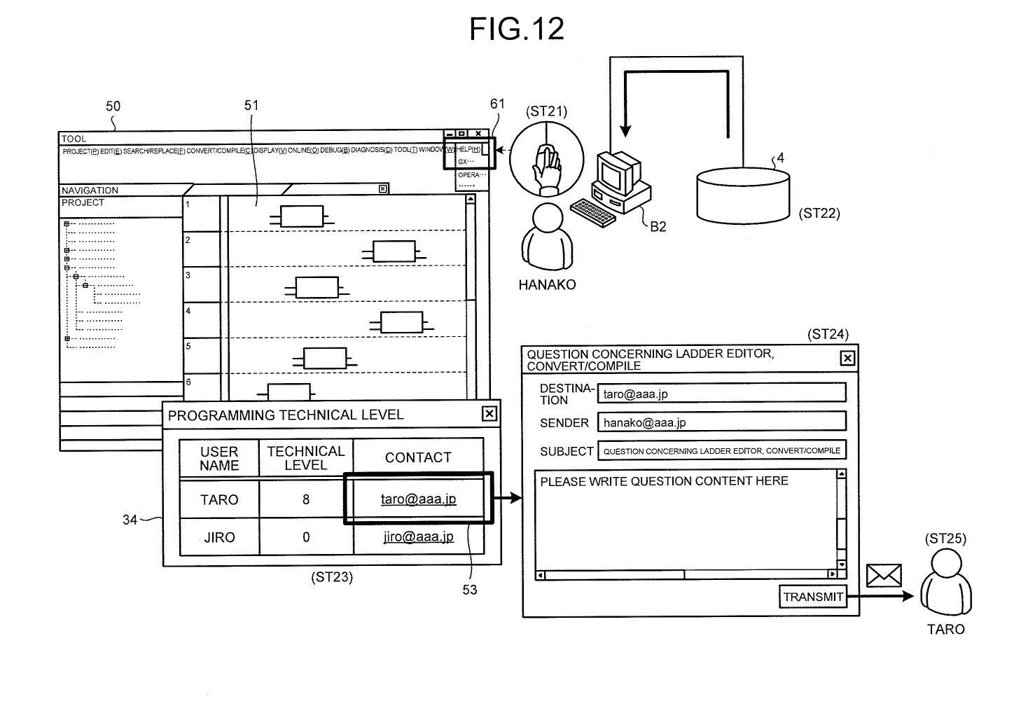

FIG. 12 is a diagram explaining process for displaying the contact details of other users simultaneously with their technical levels. In the following explanation, a flow of processing in which a user Hanako acquires technical levels and contacts of the other users using the information processing apparatus B2 is explained.

For example, when the user Hanako uses the help function 61 while using the function 51 of the tool 50 included in an information processing apparatus B2 (ST21), the information processing apparatus B2 acquires information in the technical-level recording DB 4 (ST22). Display of the help content 52 is omitted.

At this point, the information processing apparatus B2 acquires, from the technical-level recording DB 4, technician information corresponding to a type of the function used by Hanako. Specifically, the information processing apparatus B2 acquires a user name, a technical level, and a contact (a mail address, a telephone number, an address, etc.) associated with a function same as the function used by Hanako.

After acquiring the user name, the technical level, and the contact associated with the function being used, the information processing apparatus B2 displays the acquired information as technician information 34 (ST23). Thereafter, when a contact 53 is selected by Hanako, the information processing apparatus B2 displays a mail transmission screen on which a destination and the like are written in advance (ST24). When Hanako writes question content or the like in a text of a mail and performs mail transmission operation, the mail is transmitted to the selected contact (ST25). Consequently, Hanako is capable of easily transmitting the question mail to a person having a high technical level.

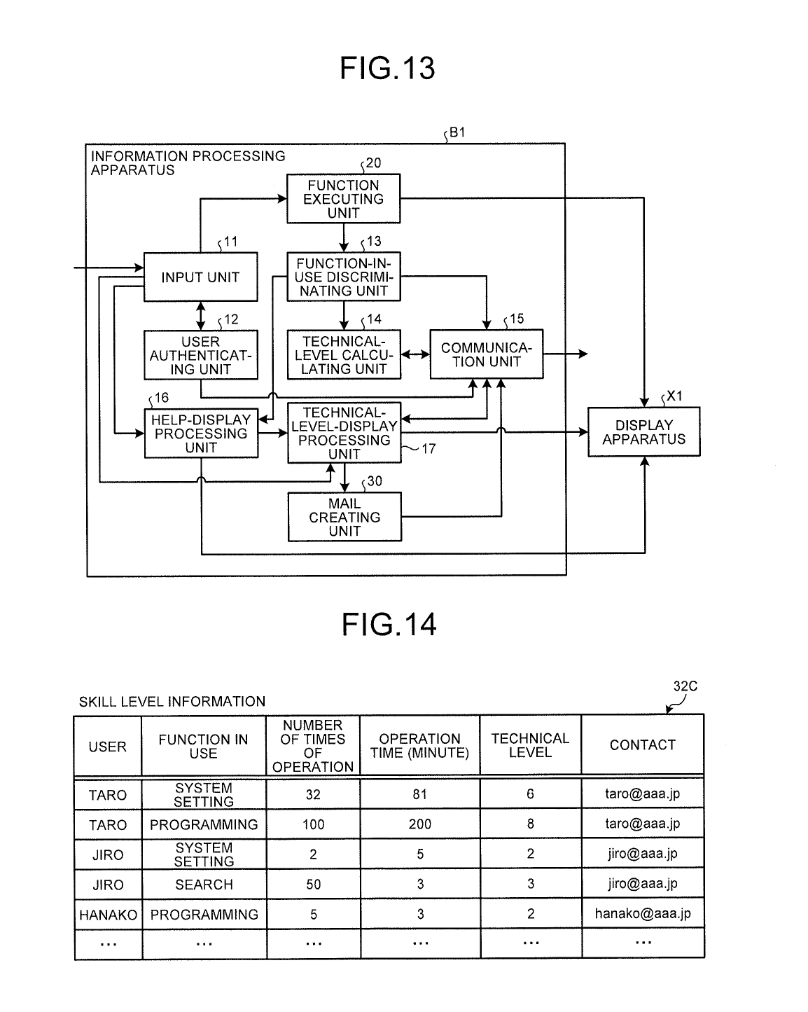

The configuration of the information processing apparatuses B1 to Bn in this embodiment is explained. FIG. 13 is a diagram illustrating the configuration of the information processing apparatus according to the second embodiment. Note that, because the information processing apparatuses B1 to Bn include the same configuration, the configuration of the information processing apparatus B1 is explained. Among components illustrated in FIG. 13, components that attain functions same as the functions of the components of the information processing apparatus A1 in the first embodiment illustrated in FIG. 4 are denoted by the same reference numerals and signs. Redundant explanation of the components is omitted.

The information processing apparatus B1 includes a mail creating unit 30 in addition to the components of the information processing apparatus A1. The mail creating unit 30 creates a mail for transmission using a model of a mail. In this embodiment, when selecting a contact of a user, who is a question partner, from a technical level list, a user inputs an instruction for designating the contact from the input unit 11. Consequently, the input unit 11 sends an instruction with the designated contact to the technical-level-display processing unit 17.

The technical-level-display processing unit 17 sends the contact corresponding to the instruction from the input unit 11 to the mail creating unit 30. Consequently, the mail creating unit 30 creates a mail for transmission. Specifically, the mail creating unit 30 sets, as a destination of the model of the mail, the contact sent from the technical-level-display processing unit 17. At this point, the mail creating unit 30 sets up, as a transmission source of the mail, a user logging in to the information processing apparatus B1 (an authenticated user). In a text of the mail created by the mail creating unit 30, a mail text is written by the user of the information processing apparatus B1. The mail creating unit 30 transmits the completed mail from the communication unit 15 to the destination.

The operation of the information processing apparatus B2 in this embodiment is the same at steps S110 to S120 explained with reference to FIG. 6 in the first embodiment. The technical-level-display processing unit 17 acquires, on the basis of the specified function in use of Hanako, a technical level list (the technician information 34) of the other users associated with the function in use from the skill level information 32X.

FIG. 14 is a diagram illustrating an example of skill level information according to the second embodiment. FIG. 14 illustrates skill level information 32C, which is an example of the skill level information 32X. The skill level information 32C is a data table in which a “user”, a “function in use”, a “number of times of operation”, an “operation time”, a “technical level”, and a “contact” are associated.

In the skill level information 32C, for example, 100 times of the “number of times of operation”, 200 minutes of the “operation time”, a level 8 of the “technical level”, and taro@aaa.jp of the “contact” are registered with respect to a combination of Taro of the “user” and programming of the “function in use”.

The technical-level-display processing unit 17 acquires a user, a technical level, and a contact from the skill level information 32C. Consequently, the technical-level-display processing unit 17 acquires the level 8 of Taro and taro@aaa.jp and the level 0 and “jiro@aaa.jp” of Jiro as a technical level list of other users concerning the function in use=programming.

Subsequently, the technical-level-display processing unit 17 displays the acquired technical level list and the help display screen, for example, simultaneously. Thereafter, when Hanako selects a contact of Taro, the main creating unit 30 creates a mail for transmission using the model of the mail. Specifically, the mail creating unit 30 creates a mail in which a destination is set in a contact (taro@aaa.jp) of Taro, who is the selected user, and a sender is set in a contact (hanako@aaa.jp) of Hanako. Further, the mail creating unit 30 sets a title prepared in advance such as “a question concerning a ladder editor and convert/compile” in a subject of the mail. The mail creating unit 30 causes the display apparatus B2 to display the mail (a mail transmission screen) on which the destination, the sender, and the subject are set.

After Hanako writes the question content in the text of the mail, the mail creating unit 30 transmits the mail to Taro. In this way, Hanako, who is a beginner of programming can ask Taro who is a user having a high technical level, a question with less labor.

Note that, when a user, who asked questions by the other users, does not answer the questions for a predetermined time or does not use the function for a predetermined time, the technical-level calculating unit 14 can lower a technical level of the user. Consequently, it is possible to accurately calculate a technical level.

For example, the mail creating unit 30 sets up, in the model of the mail, information indicating a question mail created when technical levels of the other users are presented (question mail identification information). The technical-level calculating unit 14 determines whether the question mail identification information is included in mails transmitted from the other users. When the user does not answer the questions (does not return mails) for a predetermined period although the question mail identification information is included in the mails transmitted from the other users, the technical-level calculating unit 14 can lower the technical level of the user.

The technical-level calculating unit 14 can raise or lower the technical level according to the length of a response period to the questions from the other users (e.g., a period until mail return). The technical-level calculating unit 14 can raise or lower the technical level according to the length of a period in which a function is not used.

As explained above, according to the second embodiment, because the technical levels and the contacts of the users are simultaneously displayed, it is possible to reduce labor for sending a question. Further, when a contact is a mail address, a model of a question mail can be created and presented to the user when the contact is selected. Therefore, it is possible to further reduce the labor for users to send a question.

### Third Embodiment

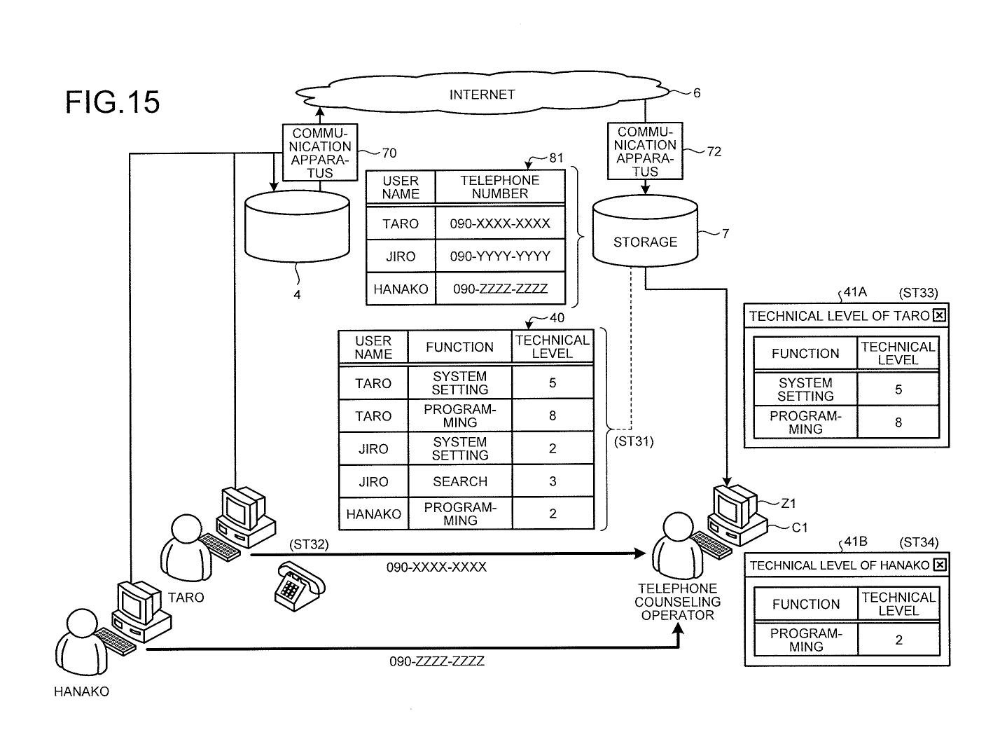

A third embodiment of the present invention is explained with reference to FIG. 15. In the third embodiment, technical levels of users are notified to a telephone counseling operator of a telephone counseling service center (a telephone counseling company). The telephone counseling operator displays the technical levels of the users during telephone counseling to execute measures corresponding to a technical level for a user seeking counseling.

FIG. 15 is a diagram explaining process for providing the telephone counseling service center with technical levels of users. Process for determining a technical level of a function is the same as the processing explained with reference to FIG. 1 and FIG. 5 in the first embodiment.

In this embodiment, the technical-level recording DB 4 of the information processing system 100A explained in the first embodiment is connected to a communication apparatus 70 that performs data communication. A storage 7 of the telephone counseling service center is connected to a communication apparatus 72 that performs data communication. The communication apparatus 70 and the communication apparatus 72 are connected via a network such as the Internet 6.

Information stored in the technical-level recording DB 4 is sent to the telephone counseling service center via the Internet 6. For example, the communication apparatus 70 extracts a combination of a “user name”, a “function”, and a “technical level” from the skill level information 32X stored in the technical-level recording dB 4 and sends the combination to the communication apparatus 72 as technician-by-function information 40. Consequently, in the telephone counseling service center, the communication apparatus 72 stores the technician-by-function information 40 in the storage 7. In the storage 7, a table (telephone number information 81) is stored, in which users (user names) and telephone numbers of users are associated.

When the technical-level calculating unit 14 updates the technical-level recording DB 4 (the skill level information 32X), the storage 7 (the technician-by-function information 40) of the telephone counseling service center is also updated (ST31). When the user performs telephone counseling concerning some function (e.g., programming), the user calls the telephone counseling service center (ST32). A telephone number of the user is communicated to the telephone counseling operator by telephone.

An information processing apparatus C1 referred to by the telephone counseling operator in the telephone counseling is connected to the storage 7. When a telephone number is input by the telephone counseling operator, the information processing apparatus C1 specifies a user name corresponding to the telephone number on the basis of the telephone number information 81 in the storage 7.

Further, the information processing apparatus C1 extracts, on the basis of the technician-by-function information 40 in the storage 7 and the specified user name, information (level-by-user information 41A, etc.) concerning a technical level of a user seeking telephone counseling. The level-by-user information 41A is information in which functions and technical levels are associated. Consequently, the information processing apparatus C1 extracts the level-by-user information 41A corresponding to the telephone number.

The information processing apparatus C1 causes a display apparatus Z1 to display the extracted level-by-user information 41A. For example, when a telephone number of Taro is input to the information processing apparatus C1, the information processing apparatus C1 causes the display apparatus Z1 to display the level-by-user information 41A of Taro (ST33). When a telephone number of Hanako is input to the information processing apparatus C1, the information processing apparatus C1 causes the display apparatus Z1 to display level-by-user information 41B of Hanako (ST34). The telephone counseling operator is capable of knowing a technical level of the questioner (the user) by observing the level-by-user information 41A and 41B displayed on the display apparatus Z1.

Note that the information processing apparatus C1 can directly access the technical-level recording DB 4 of the information processing system 100A and can acquire the level-by-user information 41A and 41B. In this case, the communication apparatuses 70 and 72 and the storage 7 are unnecessary.

As described above, according to the third embodiment, the telephone counseling operator can see the technical level of the questioner (the user). Therefore, the telephone counseling operator is capable of performing explanation (replay) using appropriate terms corresponding to the technical level of the questioner. The telephone counseling operator allocates an appropriate respondent corresponding to the technical level of the questioner. Therefore, it is possible for the operator to quickly address in response to the question.

### Fourth Embodiment

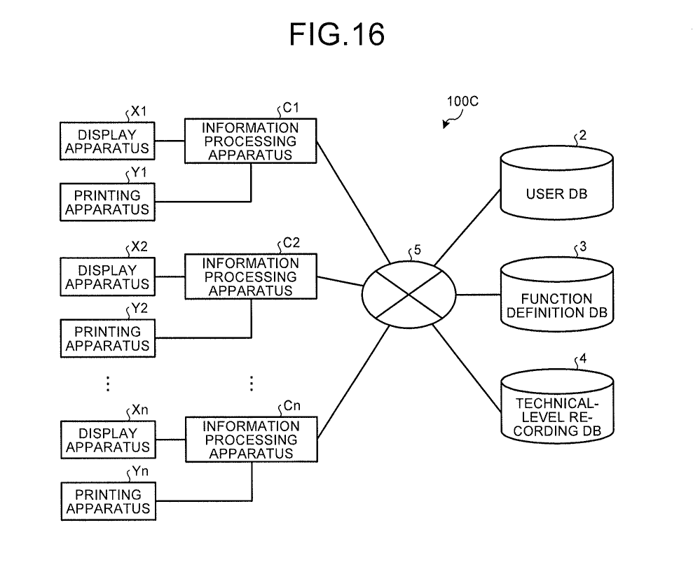

A fourth embodiment of the present invention is explained with reference to FIG. 16 to FIG. 18. In the fourth embodiment, an information processing apparatus causes a display apparatus to display a certificate for each of technical levels and causes a printing apparatus or the like to print the certificate according to a request from a user.

FIG. 16 is a diagram illustrating the configuration of an information processing system according to the fourth embodiment. In an information processing system 100C according to this embodiment, information processing apparatuses C1 to Cn are connected to the network 5 instead of the information processing apparatuses A1 to An. The information processing apparatuses C1 to Cn are connected to printing apparatuses Y1 to Yn.

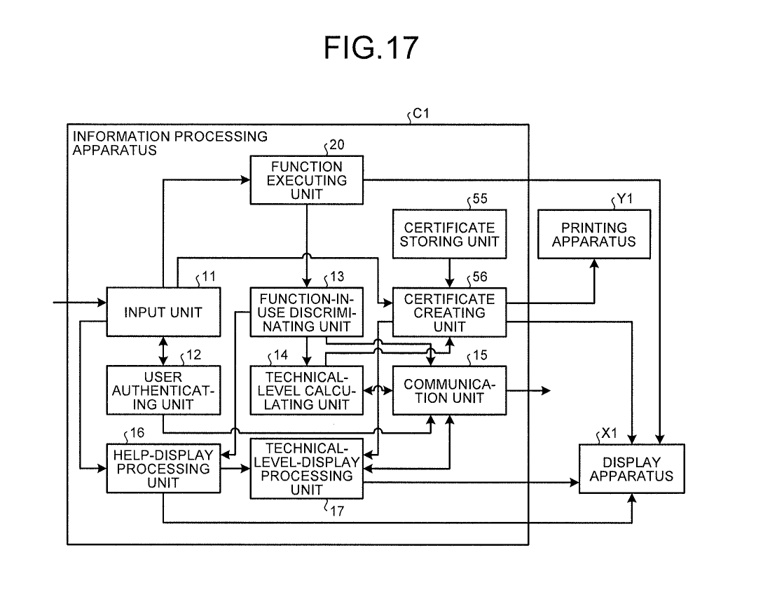

The configuration of the information processing apparatuses C1 to Cn in this embodiment is explained. FIG. 17 is a diagram illustrating the configuration of the information processing apparatus according to the fourth embodiment. Note that the information processing apparatuses C1 to Cn include the same configuration. Therefore, the configuration of the information processing apparatus C1 is explained here. Among components illustrated in FIG. 17, components having functions same as the functions of the information processing apparatus A1 in the first embodiment illustrated in FIG. 4 are denoted by the same reference numerals and signs. Redundant explanation of the components is omitted.

The information processing apparatus C1 includes a certificate-information storing unit 55 and a certificate creating unit 56 in addition to the components of the information processing apparatus A1. The certificate-information storing unit 55 is a memory or the like that stores models of certificates corresponding to technical levels and a certificate created by the certificate creating unit 56.

When calculating a technical level, if the technical level is improved from the previous technical level, the technical-level calculating unit 14 in this embodiment notifies the certificate creating unit 56 that the technical level is improved. When being notified that the technical level is improved from the previous technical level, the certificate creating unit 56 creates a certificate using a model of a certificate stored in the certificate-information storing unit 55. In the certificate created by the certificate creating unit 56, a user name, a function, and a technical level are described. The certificate creating unit 56 stores the created certificate in the certificate-information storing unit 55 and sends the certificate to the technical-level-display processing unit 17.

The technical-level-display processing unit 17 causes the display apparatus X1 to display the certificate created by the certificate creating unit 56. The certificate creating unit 56 sends the certificate to the printing apparatus Y1 according to a certificate printing instruction from the user. The printing instruction for the certificate is input to the input unit 11 by the user and sent from the input unit 11 to the certificate creating unit 56. Consequently, the certificate creating unit 56 reads, from the certificate-information storing unit 55, the certificate instructed to be printed and sends the certificate to the printing apparatus Y1.

The printing apparatuses Y1 to Yn print certificates according to instructions from the certificate creating unit 56 included in the information processing apparatuses C1 to Cn. Note that one printing apparatus can be connected to a plurality of information processing apparatuses. One information processing apparatus can be connected to a plurality of printing apparatuses.

Note that the certificate creating unit 56 can put creation process for a certificate on hold until the user instructs to create a certificate. The certificate creating unit 56 can put display process for a certificate on hold until display of a certificate is instructed by the user.

The hardware configuration of the information processing apparatuses A1 to An, B1 to Bn, and C1 to Cn is explained. Note that the information processing apparatuses A1 to An, B1 to Bn, and C1 to Cn include the same hardware configuration. Therefore, the hardware configuration of the information processing apparatus A1 is explained.

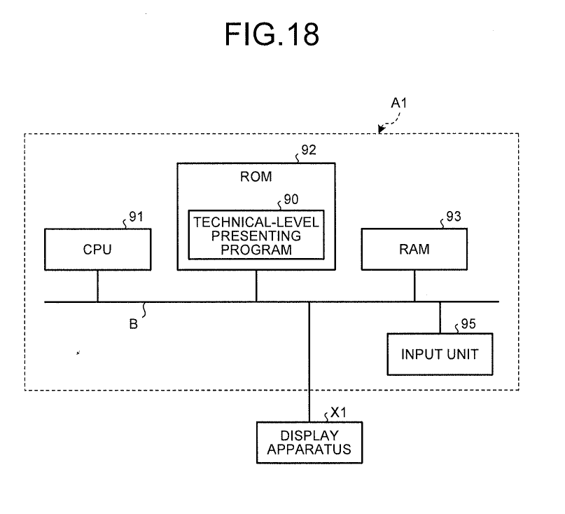

FIG. 18 is a diagram illustrating the hardware configuration of the information processing apparatus. The information processing apparatus A1 includes a CPU (Central Processing Unit) 91, a ROM (Read Only Memory) 92, a RAM (Random Access Memory) 93, a display unit 94, and an input unit 95. In the information processing apparatus A1, the CPU 91, the ROM 92, the RAM 93, and the input unit 95 are connected via a bus line B.

The CPU 91 performs calculation of a technical level and acquisition of technical level of other users using a technical-level presenting program 90 (a technical-level presenting tool), which is a computer program. The input unit 95 includes a mouse and a keyboard and receives an input of instruction information (a tool operation instruction, a help display instruction, and the like) externally input from the user. The instruction information input to the input unit 95 is sent to the CPU 91.

The technical-level presenting program 90 is stored in the ROM 92 and loaded into the RAM 93 via the bus line B. The CPU 91 executes the technical-level presenting program 90 loaded into the RAM 93. Specifically, in the information processing apparatus A1, according to an instruction input from the input unit 95 by the user, the CPU 91 reads the technical-level presenting program 90 from the ROM 92, expands the technical-level presenting program 90 in a program storage region in the RAM 93, and executes various kinds of processing. The CPU 91 temporarily stores various data generated in the various kinds of processing in a data storage region formed in the RAM 93.

The technical-level presenting program 90 executed by the information processing apparatus A1 has a module configuration including the user authenticating unit 12, the function-in-use discriminating unit 13, the technical-level calculating unit 14, and the technical-level-display processing unit 17. These units are loaded onto a main storage device and generated on the main storage device.

As explained above, according to the fourth embodiment, the certificate is printed when the technical level is improved. Therefore, the users can appeal technical levels of the users to the other users. The users are capable of checking understanding levels of the users in education for newcomers and outside training sessions.

### INDUSTRIAL APPLICABILITY

As explained above, the information processing apparatus and the information processing system according to the present invention are suitable for revealing the technical levels of users who use an engineering tool.

### REFERENCE SIGNS LIST

2 User DB
3 Function definition DB
4 Function-level recording DB
11 Input unit
12 User authenticating unit
13 Function-in-use discriminating unit
14 Technical-level calculating unit
15 Communication unit
16 Help-display processing unit
17 Technical-level-display processing unit
20 Function executing unit
30 Mail creating unit
31 Function definition information
32A to 32C, 32X Skill level information
33, 34 Technician information
35 Technical level reference information
40 Technician-by-function information
41A, 41B Level-by-user information
55 Certificate-information storing unit
56 Certificate creating unit
100A to 100C Information processing systems
A1 to An, B1 to Bn, C1 to Cn Information processing apparatuses
X1 to Xn, Z1 Display apparatuses
Y1 to Yn Printing apparatuses

1. An information processing apparatus comprising:
a function discriminating unit that discriminates types of functions of a tool operated by a first user;
a technical-level calculating unit that calculates a technical level of each of the functions used by the user on the basis of operation performance for the functions used by the user;
a communication unit that transmits, to an external storage device, technician level information in which the technical level, the first user, and the function are associated; and
a technical-level-display processing unit that
accesses, when a request for acquiring technical levels of other users is input by the first user, the external storage device via the communication unit,
acquires, from the technician level information, technical levels of the other users with respect to a function being used by the first user, and
causes a display apparatus to display the technical levels of the other users.

2. The information processing apparatus according to claim 1, wherein
the operation performance by the user includes at least one of a number of times of operation and operation time period for the function, and
the technical-level calculating unit calculates the technical level on the basis of at least one of the number of times of operation and the operation time period for a function operated by the user.

3. The information processing apparatus according to claim 1, wherein
the communication unit transmits, to the external storage device, skill level information in which the operation performance and the technician level information are associated, and
the technical-level calculating unit
calculates operation performance for a function for which operation is completed,
accesses the external storage device to acquire the operation performance in the skill level information,
calculates latest operation performance on the basis of the calculated operation performance and the acquired operation performance, and
calculates a latest technical level on the basis of the latest operation performance.

4. The information processing apparatus according to claim 1, wherein
the technical-level-display processing unit causes the display apparatus to simultaneously display technician level information concerning the other users and contact details of the other users in association with each other.

5. The information processing apparatus according to claim 4, further comprising an email creating unit that creates an email for transmission using a model of an email, wherein the email creating unit
creates, when the contact of the other user is selected by the first user, a question email about a function corresponding to the technician level information being displayed by using the model of the email, and
sets, in the created email, the selected contact details of the other user as a destination and sets the first user as a transmission source.

6. The information processing apparatus according to claim 1, further comprising
a certificate creating unit that creates, when the technical-level calculating unit calculates the technical levels and if a technical level for the function being used by the first user is improved compared with a previous technical level, a certificate by using a model of a certificate, wherein
the technical-level-display processing unit causes the display apparatus to display the certificate, and
the certificate creating unit causes a printing apparatus to display the certificate according to an instruction from the first user.

7. The information processing apparatus according to claim 1, wherein
the function of the tool includes a plurality of sub-functions, and
the technical-level calculating unit calculates, on the basis of operation performance of the sub-functions that are set in advance, a technical level for each of the sub-functions of the user.

8. The information processing apparatus according to claim 1, wherein
the function of the tool includes a plurality of sub-functions, and
the technical-level calculating unit weights each of the sub-functions and calculates a technical level for each of the functions used by the user.

9. An information processing system comprising:
a plurality of information processing apparatuses; and
a database connected to the information processing apparatuses via a first network, wherein
each of the information processing apparatuses includes:
a function discriminating unit that discriminates type of function of a tool operated by a first user;
a technical-level calculating unit that calculates a technical level of each of the functions used by the user on the basis of operation performance for the functions used by the user;
a communication unit that transmits, to the database, technician level information in which the technical level, the first user, and the function are associated; and
a technical-level-display processing unit that
accesses, when a request for acquiring technical levels of other users is input from the first user, the database via the communication unit,
acquires, from the technician level information, technical levels of the other users with respect to a function being used by the first user, and
causes a first display apparatus to display the technical levels of the other users, and
the database stores the technician level information sent from the communication unit.

10. The information processing system according to claim 9, wherein
the communication unit, when a question email to the other user that is displayed on the first display apparatus is created, transmits the created question email to the information processing apparatus of the other user, and
the technical-level calculating unit raises or lowers the technical level according to length of a period of responses to the question email from the other users or length of a period in which the function is not used.

11. The information processing system according to claim 10, further comprising:
an information acquiring apparatus
that is disposed in a telephone counseling service center and
that acquires the technician level information in the database; and
a display apparatus that is connected to the information acquiring apparatus and displays the technician level information, wherein
the information acquiring apparatus, when identification information of a user who is a person seeking telephone counseling is input,
extracts technician level information of the user on the basis of the identification information and
causes the display apparatus to display the extracted technician level information.
